(19) United States
(12) Patent Application Publication
(10) Pub. No.: US 2009/0166105 A1
(43) Pub. Date: Jul. 2, 2009

(54) Limbed vehicles, systems and methods using same, and post networks on which limbed vehicles travel

(75) Inventors: Jeffrey A. Bowers, Kirkland, WA (US); Roderick A. Hyde, Redmond, WA (US); Muriel Y. Ishikawa, Livermore, CA (US); Jordin T. Kare, Seattle, WA (US); Clarence T. Tegreene, Bellevue, WA (US); Lowell L. Wood, JR., Bellevue, WA (US); Victoria Y.H. Wood, Livermore, CA (US)

Correspondence Address: GRAYBEAL JACKSON HALEY LLP c/o Searete, 155-108th Avenue NE, Suite 350, Bellevue, WA, 98004-5973, US

(73) Assignee: Searete LLC, Bellevue, WA (US)

(21) Appl. No.: 12/006,081

(22) Filed: Dec. 28, 2007

(51) Int. Cl. B62D 57/032

(52) U.S. Cl. 180/8.6

(57) ABSTRACT

Embodiments disclosed herein relate to systems including a limbed vehicle having a plurality of controllably movable limbs (e.g., a limbed machine, limbed robot, etc.) and a plurality of spaced posts that the limbed vehicle may travel on using the controllably movable limbs. As non-limiting examples, such disclosed embodiments of systems may be used to service an agriculture field, to enable travel over an environmentally-sensitive area or an area impassable by a conventional wheeled or tracked vehicle, and may be used in many other different applications. Embodiments disclosed herein also relate to methods of operating a limbed vehicle to travel on a plurality of spaced posts, limbed vehicles, post networks, and posts.

### SUMMARY

According to one embodiment, a system includes, but is not limited to, a plurality of spaced posts and a plurality of sensor devices. The system further includes, but is not limited to, at least one limbed vehicle having a plurality of controllably movable limbs. The at least one limbed vehicle is configured to travel on the posts using the controllably movable limbs.

According to another embodiment, a system includes, but is not limited to, a plurality of spaced posts and at least one limbed vehicle including a plurality of controllably movable limbs configured to travel on the posts. The system further includes, but is not limited to, at least one memory circuitry including data corresponding to at least one of the plurality of spaced posts. The at least one limbed vehicle is configured to travel on the posts based at least in part on the data included in the memory circuitry.

According to another embodiment, a method of operating such systems includes, but is not limited to, receiving information associated a plurality of spaced posts, and directing at least one limbed vehicle to travel on the posts using limbs of the limbed vehicle based at least in part on the information.

According to another embodiment, a method includes, but is not limited to, at least partially supporting a limbed vehicle on at least one first post using at least one limb of the limbed vehicle. The method further includes, but is not limited to, responsive to at least a second limb of the limbed vehicle approaching a support structure of at least one second post, moving the support structure so that the limbed vehicle is at least partially supported thereon using the at least one second limb.

According to another embodiment, a limbed vehicle includes, but is not limited to, a plurality of controllably movable limbs, and a receiver configured to receive one or more signals containing information associated with at least post of a plurality of spaced posts. The limbed vehicle further includes, but is not limited to, a controller operably connected to the receiver. The controller is configured to direct movement of at least one of the plurality of controllably movable limbs responsive to the one or more signals.

According to another embodiment, a limbed vehicle includes, but is not limited to, a plurality of controllably movable limbs, memory circuitry, and a controller operably connected to the memory circuitry. The limbed vehicle is configured to travel on a plurality of spaced posts using the controllably movable limbs. The memory circuitry includes data associated with at least one post of a plurality of spaced posts. The controller is configured to direct movement of the controllably movable limbs based at least in part on the data included in the memory circuitry.

According to another embodiment, a post network includes, but it is not limited to, a plurality of posts distributed so that at least one limbed vehicle can travel thereon. The post network further includes a plurality of sensor devices associated with the posts. At least one of the sensor devices is configured to sense at least one characteristic associated with at least one of the posts (e.g., a position, an orientation, an occupation status, a configuration, a reactivity, or a functionality status of at least one of the posts) or predict a position of the at least one limbed vehicle.

The foregoing is a summary and thus contains, by necessity, simplifications, generalizations and omissions of detail. Consequently, those skilled in the art will appreciate that the summary is illustrative only and is NOT intended to be in any way limiting. Other aspects, features, and advantages of the systems, limbed vehicles, post networks, posts, or methods described herein, as defined by the claims, will become apparent in the detailed description set forth herein.

### BRIEF DESCRIPTION OF THE DRAWINGS

FIG. 1A is a schematic perspective view of one embodiment of a system that includes a plurality of spaced posts distributed over a surface and a limbed vehicle configured to travel on the posts.

FIG. 1B is a schematic perspective view of the system shown in FIG. 1A, with the limbed vehicle having moved to be supported by different posts.

FIG. 2 is a diagrammatic view of a remotely controlled limbed vehicle that may be employed in the system shown in FIG. 1A according to one embodiment.

FIG. 3 is a diagrammatic view of a limbed vehicle in which an operator may ride therein and direct the operation thereof according to another embodiment.

FIG. 4 is a schematic side elevation view of a post including a selectively movable support structure according to one embodiment.

FIGS. 5A-5C are top plan views of the post shown in FIG. 4, with the support structure shown in three different positions.

FIG. 6A is a schematic plan view of a post network on which a limbed vehicle can travel and a network of sensor structures according to another embodiment.

FIG. 6B is a schematic side elevation view of FIG. 6A.

FIG. 7 is a diagrammatic view of a remotely controlled limbed vehicle in which a remote-control system includes memory circuitry having data stored therein corresponding to at least one characteristic of posts on which the limbed vehicle can travel according to one embodiment.

FIG. 8 is a diagrammatic view of a limbed vehicle comprising a control system including memory circuitry having data stored therein corresponding to at least one characteristic of posts on which the limbed vehicle travels according to another embodiment.

FIG. 9A is a schematic plan view of embodiments of a system and limbed vehicle for use in servicing crops of an agriculture field.

FIG. 9B is a schematic side elevation view of the system shown in FIG. 9A depicting the limbed vehicle supported on two of the posts and servicing one of the crops.

FIG. 10 is a schematic side elevation view of a system and a limbed vehicle according to another embodiment and illustrates the manner in which a limbed vehicle and posts may be used to travel up vertical and overhanging structures.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein.

Embodiments of systems, limbed vehicles for use in the systems, and methods of using the systems are disclosed. For example, a system may include a limbed vehicle having a plurality of controllably movable limbs (e.g., a limbed machine, limbed robot, etc.), a plurality of spaced posts on which the limbed vehicle may travel using the controllably movable limbs, and a plurality of sensor devices at least one of which may be associated with at least one of the posts and configured to sense at least one characteristic associated with the at one of the posts. For example, the operation of the limbed vehicle may be directed responsive to the at least one characteristic sensed by the sensor devices, the posts may be reconfigurable responsive to the sensor devices sensing an approaching limbed vehicles, or both. Such disclosed embodiments of systems and limbed vehicles may be used to service an agriculture field, to travel over an environmentally-sensitive area, to travel over an area impassable by a conventional wheeled or tracked vehicle, or in many other different applications. As used herein, phrases such as “travel on a plurality of posts” or similar phrases such as “a plurality of posts on which the limbed vehicle travels” include, but are not limited to, the limbed vehicle making contact with the posts at a distal end of the post as well as making contact with any other portion of a post, including a side of a post.

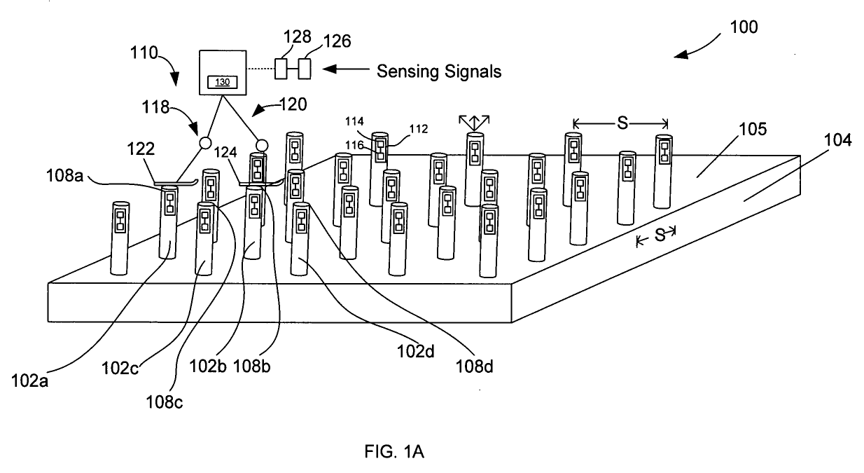

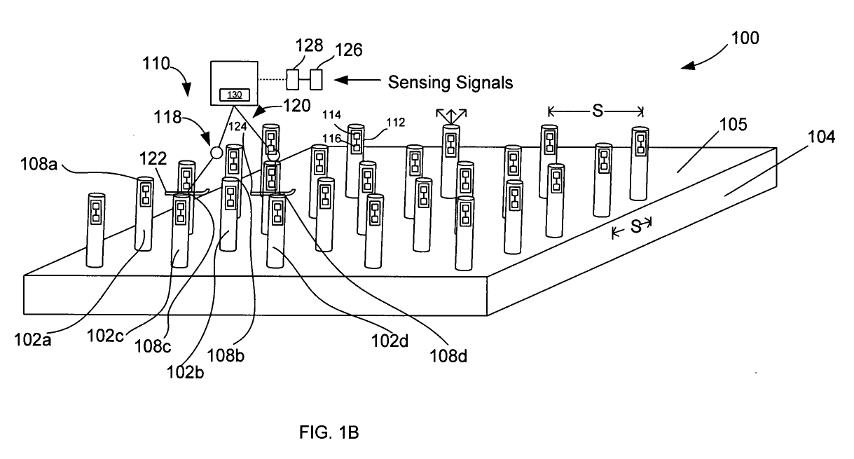

FIG. 1A is schematic perspective view of a system 100 according to one embodiment. The system 100 includes a post network comprising a plurality of spaced posts 102 (only posts 102a-102d are labeled in FIG. 1A for simplicity) that may be at least partially disposed within a medium 104 (for example, and not limited to the ground) having a surface 105. At least one post 102 may be a solid, elongated member, a generally tubular member, or another structural member having any suitable configuration. For example, at least one post 102 may be fabricated from polyvinyl chloride (“PVC”), steel, aluminum, composite materials, or another suitable structural material. At least one post 102 includes a limb-interfacing surface 108 (only limb-interfacing surfaces 108a-108d are labeled in FIG. 1A for simplicity) suitably configured to interface with a limbed vehicle 110.

The posts 102 may be at least partially embedded within the medium 104 and may project outwardly from, beyond, or above the surface 105, and further may be spaced from an adjacent post 102 by a post spacing S. However, in many embodiments, the spacing between adjacent posts 102 may not be uniform and the spacing may be tailored for specific types of applications. Although FIG. 1A shows respective posts 102 extending above the surface 105 about the same distance, in any of the embodiments disclosed herein, at least some of the posts 102 may extend above the surface 105 different distances. For example, respective posts 102 may have different lengths or may be driven into the medium 104 to different depths. Furthermore, in any of the embodiments disclosed herein, at least one, some, or all of the limb-interfacing surfaces 108 may be located substantially at or recessed below the surface 105 of the medium 104.

Installation of at least one post 102 may be performed by drilling a corresponding borehole in the medium 104 with, for example, a directional boring machine and emplacing the post 102 into the corresponding borehole. In another embodiment, a mechanized post-driving machine or another suitable apparatus may be used to emplace at least one post 102 into the medium 104. For example, such mechanized post-driving machines may be pneumatically or hydraulically actuated to drive a post 102 into medium 104.

Still referring to FIG. 1A, at least a portion of the posts 102 are associated with sensing devices 112. For example, at least one sensing device 112 may be embedded in or mounted to an exterior portion of a corresponding post 102. However, in other embodiments, at least some of or all of the posts 102 may be associated with more than one of the sensing devices 112. At least one sensing device 112 may include a sensing element 114 configured to sense at least one characteristic associated with at least one of the posts 102 and a transmitter 116 (e.g., a radio-frequency transmitter or an optical transmitter) configured to transmit one or more sensing signals at a selected electromagnetic frequency corresponding to the sensed information. According to various embodiments, at least one sensing element 114 may be configured to sense a location, an orientation, a configuration, a reactivity, a post-occupation status, or a post functionality status (e.g., whether a post 102 is broken, has fallen down, or other indicator of functionality status) of a corresponding post 102.

For example, respective sensing elements 114 may comprise a local positioning system device or a global positioning system (“GPS”) device for sensing a location of a corresponding post 102. As another example, respective sensing elements 114 may be configured to sense a reactivity of one of the posts 102, i.e., its capability to interact with momentum associated with an arriving limb of the limbed vehicle 110. The sensing element 114 may determine an elasticity, momentum damping characteristics, frictional characteristics of a portion of the post 102, mechanical nonlinear characteristics, or an energy storage capacity of a portion of the post 102. As another example, the sensing element 114 may be a load sensor configured to sense changes in load applied to a corresponding post 102 to determine whether a corresponding post 102 is occupied by the limbed vehicle 110, a thermal sensor configured to sense the presence of other objects on or near the corresponding post 102, or a machine vision system. Some of the sensor elements 114 may be configured to perform certain sensing functions, while other sensing elements 114 may be configured to perform different sensing functions. Moreover, in some embodiments, some of the posts 102 may not be associated with one of the sensor devices 112.

Still referring to FIG. 1A, the limbed vehicle 110 of the system 100 is configured to travel on the posts 102 and over the medium 104. The limbed vehicle 110 includes a plurality of controllably movable limbs 118 and 120 depicted in FIGS. 1A and 1B as two controllably movable limbs. Suitable types of limb structures include, but are not limited to, vertebrate-style limbs, limbs with one or more linear degrees of freedom, pneumatic or hydraulic tentacles, wheel- or track-limb hybrids having a rotating structure supporting multiple jointed limbs, or another suitable limb structure. While the Figures herein depict limbed vehicles comprising two controllably movable limbs for simplicity, it is contemplated that a limbed vehicle may comprise at least two limbs. For example, the limbed vehicle 110 or other limbed vehicle described herein may include three, four, five, six, seven, eight, or more, controllably movable limbs. In some embodiments, the controllably movable limbs may include legs and arms, such as more than two legs and one or more arms (not shown). Thus, as illustrated, the limbs 118 and 120 may at least one be considered legs and, in certain embodiments, the limbs 118 and 120 may have a maximum stride length at least about equal to the post spacing S. Accordingly, in some embodiments, the post spacing S may be no greater than that of the maximum stride length. An example of a limbed vehicle configured as a mobile biped vehicle is disclosed in U.S. Patent Application Publication 20050228539 (“'539 application”), which is incorporated herein by reference. In the illustrated embodiment, the limb 118 includes a foot 122 and the limb 120 includes a foot 124 on which the limbed vehicle 110 may travel by moving the limbs 118 and 120 in a walking motion, and at least one of the feet 122 and 124 may be configured, for example, as disclosed in the '539 application.

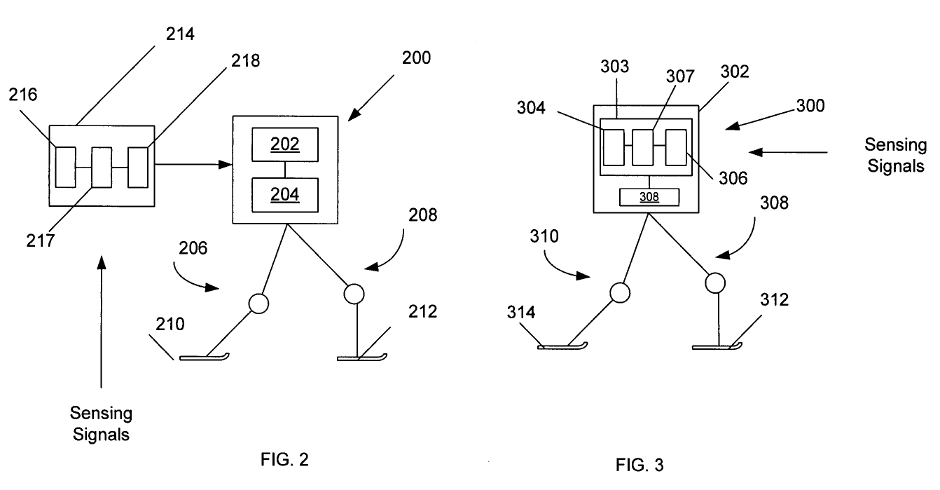

The system 100 may further include a receiver 126 operably coupled to a controller 128, at least one of which may be associated with the limbed vehicle 110. As will be described in more detail with respect to FIGS. 2 and 3, the receiver 126 and controller 128 may be included in a remote-control system configured to remotely control the operation of the limbed vehicle 110 or may be integrated into the limbed vehicle 110. The receiver 126 is configured to receive one or more sensing signals transmitted from respective sensing devices 112 and communicate the received sensing signals to the controller 128. The controller 128 is further coupled to a drive system 130 of the limbed vehicle 110 and configured to direct the operation of the limbed vehicle 110 responsive to the received sensing signals.

Responsive to the sensing signals transmitted from the sensing devices 112 to the receiver 126, the limbed vehicle 110 may be operated in a manner so that at least one of the limbs 118 and 120 is directed to move from one post 102 onto another one of the posts 102 in a walking motion. For example, with reference to FIG. 1B, the limb 118 may be directed to move so that the foot 122 thereof is moved from limb-interfacing surface 108a of post 102a on which it is supported (See FIG. 1A) onto limb-interfacing surface 108b of post 102b, followed by directing the limb 120 to move so that the foot 124 thereof is moved from limb-interfacing surface 108c of post 102c on which it is supported (See FIG. 1A) onto limb-interfacing surface 108d of post 102d. Such motion may be continued until the limbed vehicle 110 has reached a desired destination over the medium 104.

The sensing devices 112 may sense and transmit the individual locations thereof to the receiver 126, which enables the controller 128 to more accurately direct the movement of at least one of the limbs 118 and 120 onto selected posts 102. As another example, one or more of the sensor devices 112 may determine that one or more of the posts 102 are covered (e.g., by a tree) and the controller 128 may direct movement of the limbed vehicle 110 to another selected post 102.

In certain embodiments, at least one of the limbs 118 and 120 may be reconfigurable responsive, at least in part, to one or more sensing signals from at least one of the sensor devices 112. For example, at least one of the feet 122 and 124 may be configured to increase its bottom contact surface area (e.g., by deploying retractable structural members) to assist with contacting at least one of the posts 102.

In certain embodiments, the limb-interfacing surface 108 of the posts 102 may have a large enough surface area relative to the size of the feet 122 and 124 of the limbed vehicle 110 so that both of the feet 122 and 124 may be positioned on a single one of the posts 102 to support the limbed vehicle 110 thereon. Thus, in such an embodiment, the limbed vehicle 110 may be directed to travel from one of the posts 102 that supports the entire weight of the limbed vehicle 110 to another one of the posts 102 that also supports the entire weight of the limbed vehicle 110 or the limbs 118 and 120 may be directed to independently move in a manner so that the limb 118 is supported by one of the posts 102 and the limb 120 is supported by a different one of the posts 102.

As described above, the limbed vehicle 110 may be remotely controlled, may be driven by an operator that rides in the vehicle 110, or may be pre-programmed to travel along a programmed route (i.e., a sequence of the posts 102 on which the limbed vehicle 110 travels). For example, FIG. 2 is a diagrammatic view of a remotely controlled, limbed vehicle 200 according to another embodiment. The limbed vehicle 200 includes a vehicle controller 202 and a drive system 204 disposed within or on a vehicle body 205 that is operably coupled to the vehicle controller 202. The vehicle controller 202 is operable to direct the drive system 204 to controllably move limbs 206 and 208, at least one of which includes corresponding feet 210 and 212.

Still referring to FIG. 2, a remote-control system 214 is operably coupled to the vehicle controller 202 of the limbed vehicle 200 via a wireless communication link (e.g., radio-frequency communication, optical communication, etc.) or a wired communication link (e.g., a flexible cable connection). The remote-control system 214 includes a receiver 216 that is configured to receive sensing signals transmitted from sensor devices (e.g., the sensor devices 112 shown in FIGS. 1A and 1B) and an operator interface 218 (e.g., a joystick, keyboard, touchscreen monitor, combinations of any of the foregoing, or other input device) that, responsive to an operator's input, directs the operation of the vehicle 200. The remote-control system 214 further includes a controller 217 coupled to the operator interface 218 to receive operator input therefrom and coupled to the receiver 216 to receive sensing signals from the sensor devices. Instructions from the controller 217 may be communicated to the vehicle controller 202 via, for example, a transmitter/receiver combination or a wired communication link.

In operation, the remote-control system 214 communicates instructions responsive to operator input via the operator interface 216 to the vehicle controller 202 of the limbed vehicle 200 that directs the operation of the limbed vehicle 200 (e.g., independent movement of the limbs 206 and 208). For example, the accuracy of the placement of the limbs 206 and 208 may be improved because the location information of the posts on which the limbed vehicle 200 may travel may be communicated to the remote-control system 214 from individual sensor devices (e.g., sensor devices 112 shown in FIGS. 1A and 1B). Such information may be stored in memory circuitry (not shown) associated with the remote-control system 214. In other embodiments, other relevant data may be displayed on the operator interface 216 to help the operator determine where to direct the limbed vehicle 200. For example, information regarding post-occupation status or post functionality status may be communicated to the remote-control system 214. In such an embodiment, the controller 217 may determine an alternative route (i.e., a sequence of the posts on which the limbed vehicle 200 may travel) for the limbed vehicle 200 to travel. In other embodiments, the operator may select one of many possible routes that the limbed vehicle 200 may travel on the posts via the operator interface 218, and the limbed vehicle 200 may automatically travel along the selected route.

Referring to FIG. 3, in other embodiments, a limbed vehicle may include provisions (not shown) for an operator to ride in or on the limbed vehicle and control the limbed vehicle. For example, according to one embodiment, a limbed vehicle 300 includes a vehicle body 302 that is configured to support an operator and a control system 303 that comprises an operator interface 304, a receiver 306, and a controller 307 coupled to the operator interface 304 and the receiver 306. The operator interface 304 may include a joystick, touchscreen, wheel and pedal combination similar to a conventional automotive vehicle, keyboard, combinations of the foregoing, or other input device. The receiver 306 is configured to receive sensing signals transmitted from sensor devices (e.g., the sensor devices 112 shown in FIGS. 1A and 1B) and transmit the sensing signals to the operator interface 304 and the controller 307 (e.g., via a wireless or wired connection). The sensed information may be stored in memory circuitry (not shown) associated with the control system 303. The control system 303 is operably coupled to a drive system 308 of the limbed vehicle 300 configured to controllably move limbs 308 and 310, at least one of which includes corresponding feet 312 and 314. Responsive to operator input via the operator interface 304, the controller 307 may direct the drive system 308 to move at least one foot 314 and 316 from corresponding posts to other corresponding posts or to a common post, as desired, and previously described with respect to FIGS. 1A and 1B.

The accuracy of the placement of the limbs 312 and 314 may be improved because location information of the posts on which the limbed vehicle 300 may travel may be communicated to the control system 303 from individual sensor devices (e.g., the sensor devices 112 shown in FIGS. 1A and 1B), and the operator may be provided with relevant information on the operator interface 304 in a similar manner to the embodiment shown in FIG. 2.

In a further embodiment, a limbed vehicle may include a robotic control system configured to automatically direct the movement of the controllably movable limbs and other operations of the limbed vehicle.

In another embodiment, the limbed vehicle 300 may include a plurality of receivers configured to receive one or more signals emitted by respective transmitters associated with at least one post of a post network. In such an embodiment, the posts may not be associated with sensor devices because the controller 307 of the limbed vehicle 300 may triangulate a position of at least one post based on the signals emitted by the transmitters and received by the receivers. The receivers may be positioned on the limbed vehicle 300 so that the receivers are sensitive to a direction of the emitted signal from at least one post.

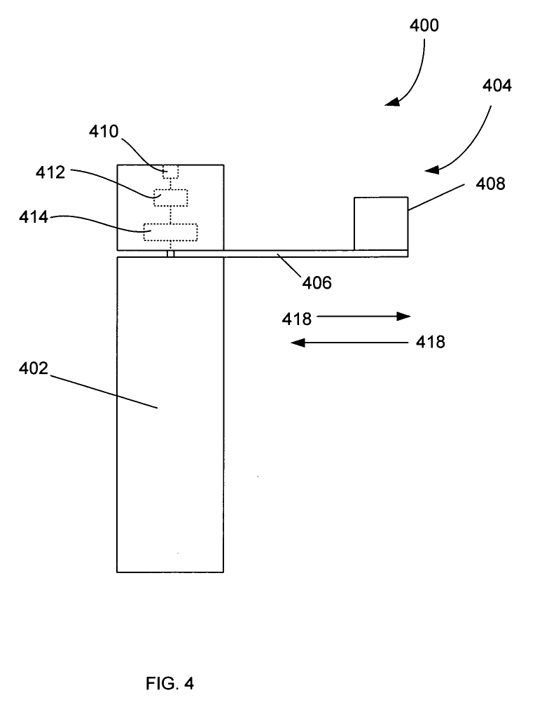

FIG. 4 is a schematic side elevation view of one embodiment of a post 400 that includes a selectively movable support structure capable of moving to support a limb of an approaching limbed vehicle, and one or more posts of a network of posts may be configured as the post 400. Such a network of posts may be employed with any of the limbed vehicles described herein or any other limbed vehicle configured to travel on spaced posts. The post 400 includes a post body 402 and a laterally-extending support structure 404 having a support arm 406 that is rotatably connected to the post body 402 via, for example, a hinge mechanism (not shown). The support arm 406 carries a limb-engagement member 406, such as a cup or platform configured to receive a foot from a limb of any of the previously described limbed vehicles. The post 400 further includes or may be associated with a predicative sensor 410 configured to sense the presence of a limbed vehicle, track an approaching limb of the limbed vehicle, and predict a location of the approaching limb. For example, the predicative sensor 410 may be a machine vision system or another suitable sensor. The predicative sensor 410 is coupled to a controller 412, and the controller 412 is coupled to an actuator 414 that is configured to selectively retract the support arm 406 laterally in a direction 416, selectively extend the support arm 406 laterally in a direction 418, and selectively rotate the support arm 406.

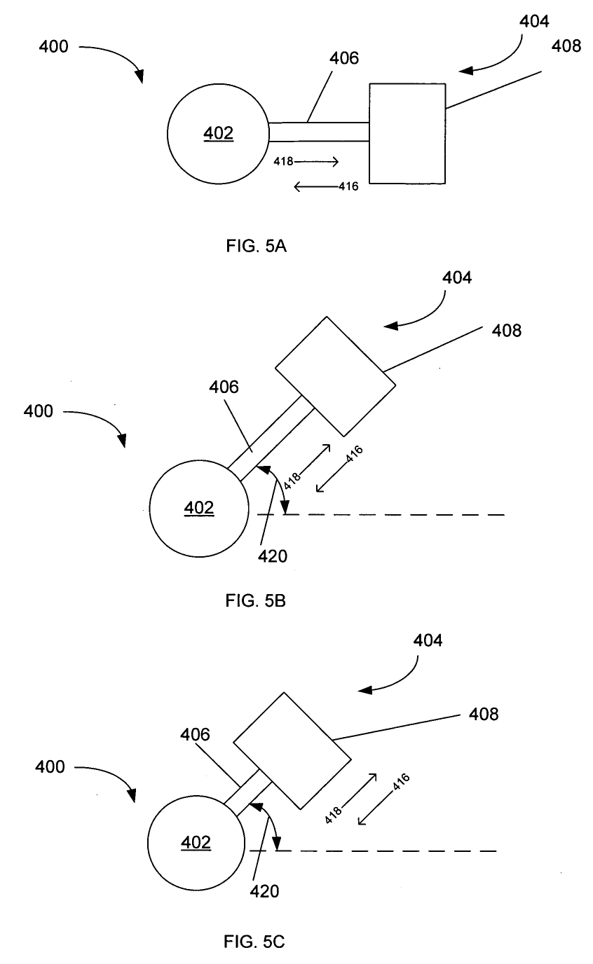

Referring to FIGS. 5A and 5B, in operation, the controller 412 may instruct the actuator 414 to rotate the support structure 404 a selected angle 420 responsive to one or more sensing signals received from the predicative sensor 410 indicating where an approaching foot of a limbed vehicle is likely going to land. Referring to FIG. 5C, the support arm 406 of the support structure 404 may also be retracted in the direction 416 (or extended in direction 418), as needed, to ensure that the limb-engagement member 408 is in a position to receive a foot of a limbed vehicle.

In another embodiment, the limbed vehicle 110 may include a transmitter configured to transmit one or more signals to a receiver associated with the post 400. For example, the predictive sensor 410 may be replaced with a receiver configured to receive the one or more signals transmitted from the transmitter and transmit the received one or more signals to the controller 412 that moves the support structure 404 to a selected orientation responsive to the received one or more signals. In other embodiments, the receiver may used in addition to the predicative sensor 410.

In other embodiments, a limbed vehicle may include at least one sensor device. In such embodiments, the limbed vehicle may change configuration based on information sensed by the at least one sensor device. For example, at least one of the feet of the limbed vehicle may change configuration responsive to sensed information. In other embodiments, the limbed vehicle may deploy specific functional devices responsive to the sensed information, such as deploying protective inflatable structures when the limbed vehicle has sensed its location and determined that it is traveling or anticipating traveling over water. In further embodiments, the limbed vehicle may instruct the posts to change configuration responsive to information sensed by the limbed vehicle. For example, the limbed vehicle may communicate its sensed location to at least one post, which may deploy a selectively deployable platform responsive to instructions from the limbed vehicle to provide a larger limb-interfacing surface.

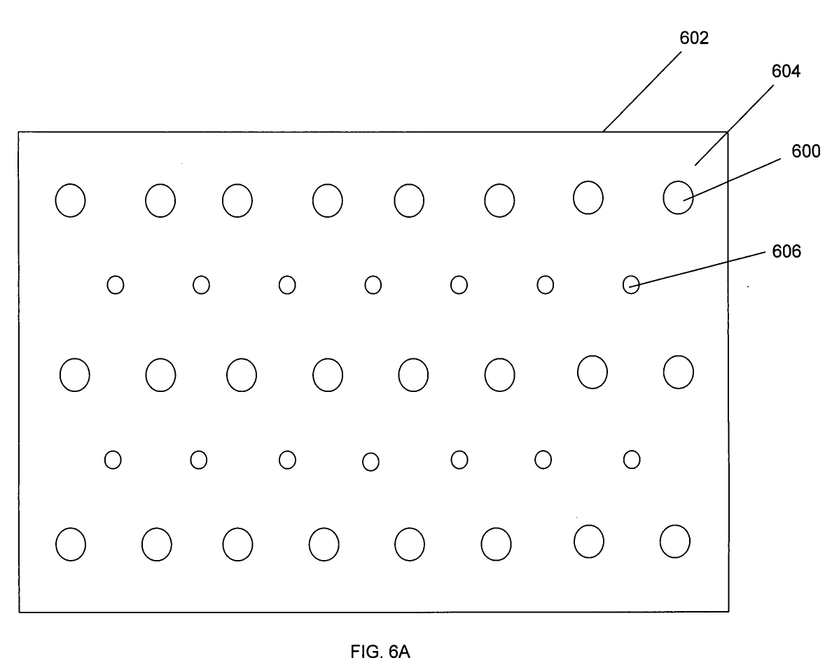

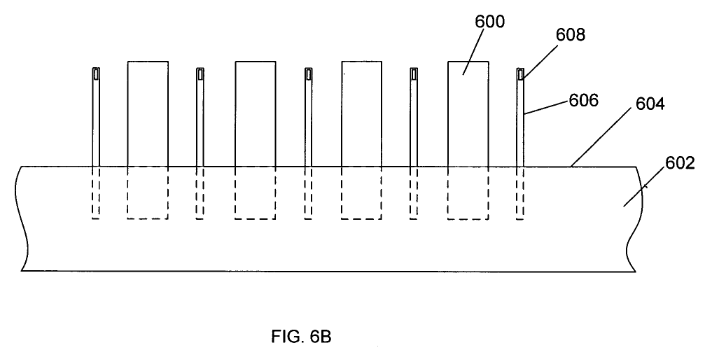

Referring to FIGS. 6A and 6B, although the sensing devices described above (e.g., the sensing devices 112 shown in FIGS. 1A and 1B) are illustrated as being attached to one of the posts 102, in other embodiments, at least some of the sensing devices may be spatially separated from the posts 102. FIGS. 6A and 6B illustrate a post network including a plurality of posts 600 at least partially disposed in a medium 602 (e.g., the ground), with at least one post 600 projecting above a surface 604 of the medium 602. Any of the previously described limbed vehicles are capable of traveling on the posts 600. A network of sensor structures 606 may also be distributed among the posts 600 and at least partially disposed in the medium 602. For example, sensor structure 606 may be a post that is relatively weaker than the posts 600 because it will not bear a significant amount of weight. At least one sensor structure 606 may include a sensing device 608 configured as any of the previously described sensor devices. At least one sensor structure 606 may be associated with one or more of the posts 600. For example, at least one sensor device 608 of a respective sensor structure 606 may transmit one or more sensing signals corresponding to position information of at least one, at least two, or another selected number of posts 600 to a limbed vehicle or a remote-control system. In other embodiments, at least one sensor device 608 of a respective sensor structure 606 may transmit sensing signals to a limbed vehicle corresponding to the occupation status of at least one, at least two, or another selected number of posts 600.

In certain embodiments, the sensor devices 608 may be disposed in or proximate to the medium 602 so that the sensor devices 608 may sense a characteristic of the medium 602. For example, the sensor devices 608 may be configured to sense temperature of the medium 602, moisture content of the medium 602, or another selected characteristic of the medium 602. For example, in an agriculture medium, such as a crop field, a sensor device 608 may be configured to sense the nutrient or moisture content of the soil.

In certain embodiments, at least one sensor device may transmit sensed information to at least one memory circuitry within an associated post, or the sensed information may be transmitted to at least one limbed vehicle. Further, sensed information may be transmitted to an operator located in a limbed vehicle or remotely located. The sensed information obtained may be analyzed (for example, computationally) to determine a potential course of action of at least one limbed vehicle. By way of non-limiting example, at least one limbed vehicle may receive sensed information about a sub-optimal level of nutrient content in the soil of at least one region of a crop field. The at least one limbed vehicle may be programmed to then travel to such at least one region to deliver needed nutrient to the soil.

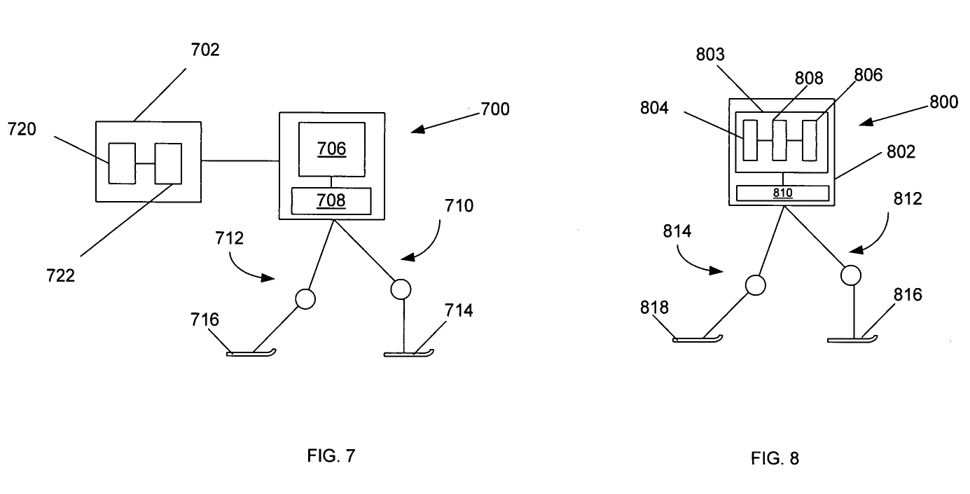

Referring to FIG. 7, in other embodiments, a limbed vehicle may include memory circuitry having data stored therein corresponding to individual posts of at least a portion of the posts as an alternative to or in addition to the use of the sensor devices. FIG. 7 is a diagrammatic view of a limbed vehicle 700 operably coupled to a remote-control system 702. The limbed vehicle 700 may include a vehicle body 704 housing a controller 706 that is operably coupled to a drive system 708. The limbed vehicle 700 further includes controllably movable limbs 710 and 712 having corresponding feet 714 and 716. The controller 706 may direct the drive system 708 to move the limbs 710 and 712 in a walking motion, as previously described with respect to the limbed vehicle 110 shown in FIGS. 1A and 1B. The remote-control system 702 may include an operator interface 720, such as a joystick, keyboard, touchscreen monitor, combinations of any of the foregoing, or other input device configured to allow the operator to control the limbed vehicle 700 or select certain operational parameters for the limbed vehicle 700. The remote-control system 702 further includes memory circuitry 722 (e.g., flash memory, read only memory, random access memory, or any memory device or storage medium) that may include data stored therein corresponding to at least one characteristic of individual posts of a plurality of spaced posts (e.g., at least a portion of the posts 102 shown in FIGS. 1A and 1B), such as locations of individual posts, post orientation of individual posts, or other characteristic of individual posts. For example, the at least one characteristic may be post location, post-occupation status, post configuration, or post reactivity. In some embodiments, the data may include a number of different routes along which the limbed vehicle 700 may travel on the posts and over a medium.

In one mode of operation, the operator may direct the operation of the limbed vehicle 700 via input into the operator interface 720 of the remote-control system 702. The accuracy of the placement of the limbs 710 and 712 may be improved because location information of the posts on which the limbed vehicle 700 may travel are known. In another mode of operation, the operator may select via the operator interface 720 of the remote-control system 702 one of many possible routes along which the limbed vehicle 700 may travel on the posts. The selected route may be communicated to the controller 706 of the limbed vehicle 700, which directs the drive system 708 to move the limbs 710 and 712 in a manner so that the limbed vehicle 700 moves along the selected route.

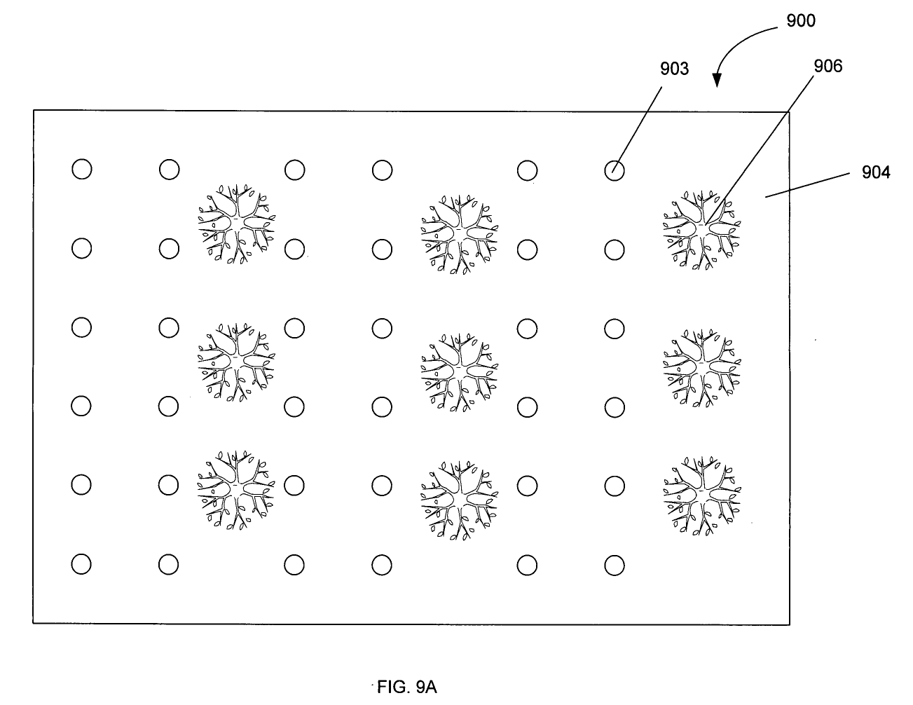

FIG. 8 is a diagrammatic view of another embodiment of a limbed vehicle 800. The limbed vehicle 800 differs from the limbed vehicle 700 in that a control system integrated with the limbed vehicle 800 includes memory circuitry having data stored therein corresponding to locations of at least one of a plurality of spaced posts. The limbed vehicle 800 may include provisions (not shown) for an operator to ride therein or thereon and control the limbed vehicle. For example, the limbed vehicle 800 includes a vehicle body 802 that is configured to support an operator and a control system 803 that comprises an operator interface 804, memory circuitry 806 (e.g., flash memory, read only memory, random access memory, or any memory device or storage medium) having data stored therein corresponding to individual locations of a plurality of spaced posts (e.g., at least a portion of the posts 102 shown in FIG. 1A), and a controller 808 coupled to the operator interface 804 and the memory circuitry 806. The operator interface 804 may include a joystick, touchscreen, wheel and pedal combination similar to a conventional automotive vehicle, keyboard, combinations of the foregoing, or other input device. The controller 808 is operably coupled to a drive system 810 of the limbed vehicle 800 configured to controllably move limbs 812 and 814, at least one of which includes corresponding feet 816 and 818. Responsive to operator input via the operator interface 804, the controller 808 may direct the movement of the limbs 812 and 814 to enable travel on the posts.

The accuracy of the placement of the limbs 812 and 814 may be improved because location information of the posts on which the limbed vehicle 800 may travel are known, and the operator may select via the operator interface 804 of the control system 803 one of many possible routes along which the limbed vehicle 800 may travel on the posts in a manner similar to the embodiment shown in FIG. 7.

In a further embodiment, a limbed vehicle including the memory circuitry having data stored therein corresponding to at least one characteristic of individual posts may also include a robotic control system configured to automatically direct the movement of the controllably movable limbs and other operations of the limbed vehicle.

In any of the above-described limbed vehicle embodiments, the limbed vehicle may include at least one transmitter configured to send a request for information from at least one sensing device, such as at least one of the sensor devices 112 shown in FIGS. 1A and 1B. In such an embodiment, requested information may be any information that the sensor device 112 is capable of sensing (e.g., post orientation, post location, etc.), and the information may be transmitted to a receiver associated with the limbed vehicle. In other embodiments, the at least one transmitter is configured to transmit energy (e.g., one or more beams of electromagnetic radiation having a selected frequency) that is reflected from one or more posts as one or more reflected signals. Such one or more reflected signals may be received by a receiver operably connected to the limbed vehicle, and provide information, such as at least one post location, at least one post orientation, at least post occupation status, at least post configuration, at least one post orientation, at least one post functionality status, or other characteristic associated with at least one post.

The embodiments of limbed vehicles and systems previously described may be employed in a variety of different application environments. Turning again to FIG. 1A, for example, the medium 104 may be an environmentally-sensitive region (e.g., a riverbed, lakebed, wetland, marsh, grass land, forest, a region or area provided environmental protection by a governmental entity, etc.) and, thus, the surface 105 may be an environmentally-sensitive area. In such an embodiment, the posts 102 may enable the limbed vehicle 110 to travel over the environmentally-sensitive area without causing substantially any damage so that, for example, equipment or supplies may be transported. In another embodiment, the medium 104 may be an ocean, sea, lake, or other liquid body and the posts 102 extend above, or limb-interfacing surfaces 108 thereof are located below or substantially at a surface of the liquid body to enable the limbed vehicle 110 to travel over the liquid body. In another embodiment, the medium 104 may be a substantially impassable with a conventional wheeled or tracked vehicle (e.g., an automobile or a tractor). For example, the medium 104 may be a marsh area, a swamp, closely-spaced trees, or other medium that is substantially impassable by a conventional wheeled or tracked vehicle. In such an embodiment, the system 100 or any other system or limbed vehicle described herein may enable transport of goods, people, etc. over the medium 104 in an efficient manner. In other embodiments, the medium 104 may be an agriculture field.

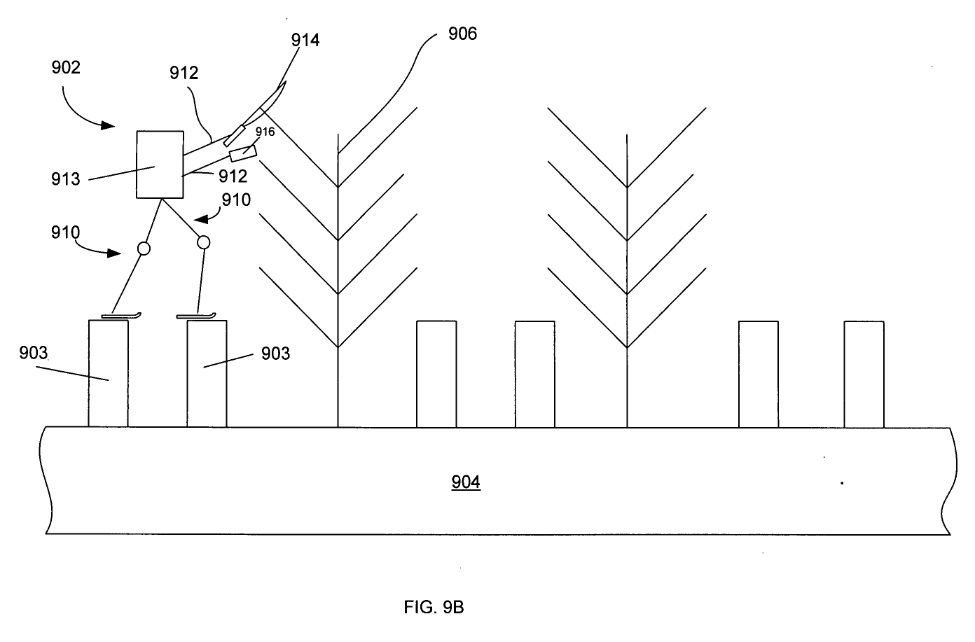

FIGS. 9A and 9B illustrate embodiments of a system 900 and a limbed vehicle 902 utilized in an agriculture environment. It should be understood that any of the previously described limbed vehicles, systems, and post configuration may be employed in such an agriculture environment. The system 900 includes a plurality of spaced posts 900 that may be arranged in rows and columns. For example, two rows of posts 903 may be positioned in an agriculture field 904 on either side of a row of crops 906.

Referring to the schematic side elevation view of the system 900 in FIG. 9B, post 903 is disposed within the agriculture field 904 using any of the previously described installation techniques and extends a sufficient distance above the agriculture field 904 so that a limbed vehicle 908 of the system 900 that travels thereon may access the crops 906. The limbed vehicle 902 may include a plurality of controllably movable legs 910 projecting from a vehicle body 913. One of the legs 910 is shown supported by one of the posts 903 and the other leg 910 is shown supported by another one of the posts 903. The limbed vehicle 908 may also include a plurality of arms 912. For example, one or more of the arms 912 may include a gripping mechanism (e.g., multi-fingered hand). One of the arms 912 may hold an agriculture tool 914 (e.g., shears or other suitable tool) and the other arm 912 may carry an end effector 916 that may be configured to operate in conjunction with the agriculture tool 914. For example, the end effector 916 may comprise a vacuum tool, a multi-fingered hand, or another suitable end effector configured to pick-up crops cut by the agriculture tool 914. As another example, the agriculture tool 914 may be omitted and at least one arm 912 may include a multi-fingered hand configured to pick or otherwise service the crops 906. In another embodiment, the agriculture tool 914 may be configured to apply useful reagents or other substances to the agriculture field 904 or the crops 906, such as fertilizer, pesticide, or seeds.

In operation, the limbed vehicle 902 may be directed to travel on the posts 903, as previously described with respect to any of the other embodiments, and service selected crops 906 while supported on one or more posts 903. For example, the limbed vehicle 902 may include a control system (not shown) or may be operably coupled to a remote-control system (not shown) that receives one or more sensing signals transmitted from sensor devices associated with the posts 903, or the control system (not shown) or remote-control system (not shown) may include memory circuitry having data stored therein corresponding to a location of at least one post 903, as previously described.

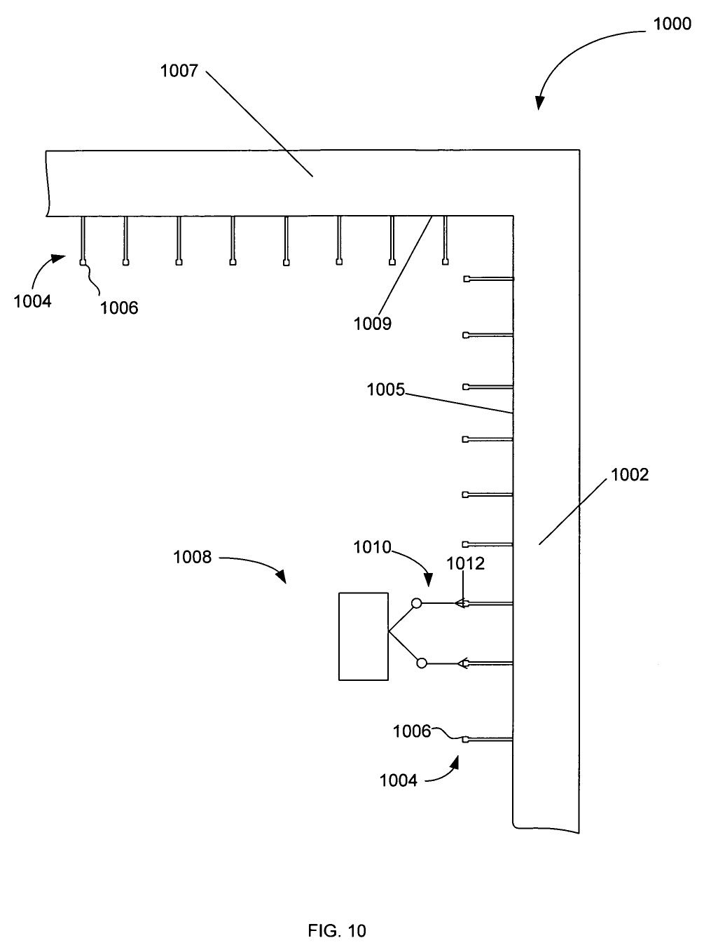

FIG. 10 is a schematic side elevation view of a system 1000 according to another embodiment and illustrates the manner in which a limbed vehicle and posts may be used to travel vertically and on overhanging structures. The system 1000 includes a vertical structure 1002 (e.g., a wall) having a plurality of spaced posts 1004 projecting outwardly from a substantially vertical surface 1005 thereof and a horizontal structure 1007 (e.g., a ceiling) having a plurality of the spaced posts 1004 projecting downwardly from a substantially horizontal surface 1009 thereof. At least one post 1004 may include a flange portion 1006 to facilitate gripping by a limbed vehicle 1008 of the system 1000. However, in other embodiments, the flange portion 1006 may be omitted. The limbed vehicle 1008 may include a plurality of controllably movable limbs 1010, at least one of which includes a gripping mechanism 1012 configured to grip a flange portion 1006 of one of the posts 1004. For example, at least one gripping mechanism 1012 may comprise a multi-fingered hand that is configured to grip a flange portion 1006 with sufficient strength to enable the limbed vehicle 1008 to travel vertically on the posts 1004 projecting from the vertical structure 1002 and horizontally on the downwardly projecting posts 1004 projecting from the horizontal structure 1005.

In operation, the limbed vehicle 1008 may be directed to vertically ascend on the posts 1004 extending from the vertical structure 1002 by moving the limbs 1010 in a walking motion and gripping at least one post 1004 that the individual limbs 1010 contact. The limbed vehicle 1008 may also be directed to travel horizontally on the posts 1004 extending downwardly from the horizontal structure 1005 in a similar manner. For example, the limbed vehicle 1008 may include a control system (not shown) or may be operably coupled to a remote-control system (not shown) that receives one or more sensing signals (e.g., signals from at least one post 1004 indicative of post orientation or location) transmitted from sensor devices associated with the posts 1004, as previously described. The limbed vehicle 1008 may alternatively include a control system (not shown) or may be operably coupled to a remote-control system (not shown) that includes memory circuitry having data stored therein corresponding to a location or orientation of at least one post 1004, as previously described.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes, systems, or other technologies described herein can be effected (e.g., hardware, software, or firmware), and that the preferred vehicle will vary with the context in which the processes, systems, or other technologies are deployed. For example, if an implementer determines that speed and accuracy are paramount, the implementer may opt for a mainly hardware or firmware vehicle; alternatively, if flexibility is paramount, the implementer may opt for a mainly software implementation; or, yet again alternatively, the implementer may opt for some combination of hardware, software, or firmware. Hence, there are several possible vehicles by which the processes, devices, or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices or processes via the use of block diagrams, flowcharts, or examples. Insofar as such block diagrams, flowcharts, or examples contain one or more functions or operations, it will be understood by those within the art that each function or operation within such block diagrams, flowcharts, or examples can be implemented, individually or collectively, by a wide range of hardware, software, firmware, or virtually any combination thereof. In one embodiment, several portions of the subject matter described herein may be implemented via Application Specific Integrated Circuits (“ASICs”), Field Programmable Gate Arrays (“FPGAs”), digital signal processors (“DSPs”), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (“CD”), a Digital Video Disk (“DVD”), a digital tape, a computer memory, etc.; and a transmission type medium such as a digital or an analog communication medium (e.g., a fiber optic cable, a waveguide, a wired communications link, a wireless communication link, etc.).

In a general sense, based on the disclosure contained herein those skilled in the art will recognize that the various aspects described herein which can be implemented, individually or collectively, by a wide range of hardware, software, firmware, or any combination thereof can be viewed as being composed of various types of “circuitry.” Consequently, as used herein “circuitry” includes, but is not limited to, circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment). Those having skill in the art will recognize that the subject matter described herein may be implemented in an analog or digital fashion or some combination thereof.

The herein described components (e.g., steps), devices, and objects and the description accompanying them are used as examples for the sake of conceptual clarity and that various configuration modifications using the disclosure provided herein are within the skill of those in the art. Consequently, as used herein, the specific exemplars set forth and the accompanying description are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural or singular terms herein, those having skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable”, to each other to achieve the desired functionality. Specific examples of operably couplable include but are not limited to physically mateable or physically interacting components or wirelessly interactable or wirelessly interacting components or logically interacting or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an”; the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, or A, B, and C together, etc.). Virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those of ordinary skilled in the art. The various aspects and embodiments disclosed herein are for purposes of illustration and are not intended to be limiting.

1. A system, comprising:
a plurality of spaced posts;
a plurality of sensor devices; and
at least one limbed vehicle including a plurality of controllably movable limbs, the at least one limbed vehicle configured to travel on at least one of the plurality of spaced posts using at least one of the plurality of controllably movable limbs.

2. The system of claim 1, wherein at least one of the plurality of sensor devices is operably connected to a corresponding one of the posts.

3. The system of claim 1, wherein at least one of the sensor devices is associated with at least one of the plurality of spaced posts.

4. The system of claim 1, wherein the at least one limbed vehicle is configured to travel on at least one of the plurality of spaced posts responsive to one or more sensing signals received from at least one of the plurality of sensor devices.

5. The system of claim 1, wherein:
at least one of the plurality of sensor devices includes:
at least one sensing element configured to sense information; and
at least one transmitter configured to transmit one or more sensing signals, corresponding to the information sensed by the at least one sensing element, to the at least one limbed vehicle; and
the at least one limbed vehicle is configured to travel on at least one of the plurality of spaced posts responsive to the one or more sensing signals.

6. The system of claim 5, further comprising:
a control system including:
at least one receiver configured to receive the one or more sensing signals transmitted from the at least one transmitter; and
at least one controller operably coupled to the at least one receiver and configured to direct movement of the at least one limbed vehicle responsive to receiving the one or more sensing signals from the at least one receiver.

7. The system of claim 1, wherein at least one of the sensor devices is spatially separate from at least one of the plurality of spaced posts.

8. The system of claim 1, wherein at least one of the sensor devices is configured to communicate at least one characteristic of at least one post of the plurality of spaced posts to a control system.

9. The system of claim 8, wherein the at least one characteristic is at least one post location, at least one post-occupation status, at least one post configuration, at least one post reactivity, at least one post orientation, or at least one post functionality status.

10. The system of claim 1, wherein at least one of the plurality of sensor devices is configured to sense information about an environment in which the at least one post is disposed.

11. The system of claim 1, wherein at least one of the plurality of sensor devices is configured as a predicative sensor.

12. The system of claim 1, further comprising:
a control system operably coupled to at least one of the plurality of sensor devices and configured to control the operation of the at least one limbed vehicle responsive to one or more sensing signals received from the at least one of the plurality of sensor devices.

13. The system of claim 12, wherein the at least one limbed vehicle includes the control system.

14. The system of claim 12, wherein the control system is configured to determine a route along which the at least one limbed vehicle can travel on the at least one of the plurality of spaced posts responsive at least in part to the one or more sensing signals.

15. The system of claim 12, wherein the control system includes an operator interface through which a route across at least two of the plurality of spaced posts can be selected based at least in part on the one or more sensing signals.

16. The system of claim 12, wherein the control system is configured as a remote-control system.

17. The system of claim 12, wherein the control system is configured as a robotic control system.

18. The system of claim 1, wherein at least one of the plurality of spaced posts is reconfigurable responsive at least in part to one or more sensing signals from at least one of the plurality of sensor devices.

19. The system of claim 18, wherein the at least one of the plurality of spaced posts includes a support structure configured to be controllably movable responsive to the one or more sensing signals from the at least one of the plurality of sensor devices.

20. The system of claim 1, wherein at least one of the plurality of controllably movable limbs is reconfigurable responsive at least in part to one or more sensing signals from at least one of the plurality of sensor devices.

21. The system of claim 1, wherein at least one of the plurality of spaced posts is disposed at least partially in a medium.

22. The system of claim 21, wherein the medium includes an agriculture field.

23. The system of claim 22, wherein the plurality of controllably movable limbs includes one or more arms, at least one of the one or more arms carrying an agriculture tool.

24. The system of claim 21, wherein the medium includes an environmentally-sensitive area.

25. The system of claim 1, wherein at least a portion of the plurality of controllably movable limbs of the limbed vehicle includes a plurality of legs and a plurality of arms.

26. A system, comprising:
a plurality of spaced posts;
at least one memory circuitry including data corresponding to at least one of the plurality of spaced posts; and
at least one limbed vehicle including a plurality of controllably movable limbs, the at least one limbed vehicle configured to travel on at least one of the plurality of spaced posts using at least one of the plurality of controllably movable limbs based at least in part on the data included in the memory circuitry.

27. The system of claim 26, wherein the data includes information corresponding to a plurality of different routes along which the at least one limbed vehicle can travel.

28. The system of claim 26, wherein the data includes information corresponding to at least one characteristic of at least one of the plurality of spaced posts.

29. The system of claim 28, wherein the at least one characteristic is at least one post location, at least one post-occupation status, at least one post configuration, at least one post reactivity, at least one post functionality status, or at least one post orientation.

30. The system of claim 26, wherein:
the data includes information corresponding to a plurality of different routes; and
the at least one limbed vehicle includes an operator interface through which at least one of the routes can be selected.

31. The system of claim 26, further comprising:
a remote-control system including:
the at least one memory circuitry, the data of the memory circuitry including information corresponding to a plurality of different routes; and
an operator interface through which at least one of the routes can be selected.

30. The system of claim 26, wherein the at least one limbed vehicle is operably connected to a remote-control system that includes the at least one memory circuitry.

32. The system of claim 26, wherein the at least one limbed vehicle includes a control system configured to direct the operation of the at least one limbed vehicle and includes the at least one memory circuitry.

33. The system of claim 26, wherein the at least one limbed vehicle is associated with a robotic control system.

34. The system of claim 26, wherein the at least one memory circuitry includes at least one memory device or at least one storage medium.

35. The system of claim 26, wherein at least one of the plurality of spaced posts is reconfigurable responsive at least in part to one or more sensing signals from at least one sensor device associated with the at least one of the posts.

36. The system of claim 35, wherein the at least one of the plurality of spaced posts includes a support structure configured to be selectively moved responsive to the one or more sensing signals from the at least one sensor device.

37. The system of claim 26, wherein at least one of the plurality of spaced posts is reconfigurable responsive at least in part to one or more signals from the at least one limbed vehicle.

38. The system of claim 26, wherein the at least one of the plurality of spaced posts is disposed at least partially in a medium.

39. The system of claim 38, wherein the medium includes an agriculture field.

40. The system of claim 38, wherein the medium includes an environmentally-sensitive area.

41. The system of claim 26, wherein the plurality of controllably movable limbs includes one or more arms, at least one of the one or more arms carrying an agriculture tool.

42. The system of claim 26, wherein the plurality of controllably movable limbs of the at least one limbed vehicle includes a plurality of legs.

43. The system of claim 26, wherein the plurality of controllably movable limbs of the at least one limbed vehicle includes a plurality of arms.

44. A method, comprising:
receiving information associated with a plurality of spaced posts; and
directing at least one limbed vehicle to travel on at least one of the plurality of spaced posts using at least one limb of the limbed vehicle based at least in part on the information.

45. The method of claim 44, wherein receiving information associated with a plurality of spaced posts includes:
receiving sensing information associated with at least one of the spaced posts.

46. The method of claim 45, wherein receiving sensing information associated with at least one of the spaced posts includes:
receiving a respective position of the at least one of the spaced posts.

47. The method of claim 45, wherein receiving sensing information associated with at least one of the spaced posts includes:
receiving a respective occupation status of the at least one of the spaced posts.

48. The method of claim 45, wherein receiving sensing information associated with at least one of the spaced posts includes:
receiving a respective orientation of the at least one of the spaced posts.

49. The method of claim 44, wherein receiving information associated with a plurality of spaced posts includes:
receiving the information at a remote-control system in communication with the at least one limbed vehicle.

50. The method of claim 49:
wherein the information is associated with a plurality of routes; and
further comprising selecting at least one of the plurality of routes along which the limbed vehicle can be directed.

51. The method of claim 44, wherein receiving information associated with a plurality of spaced posts includes:
accessing the information from memory circuitry of a control system of the at least one limbed vehicle.

52. The method of claim 44, wherein receiving information associated with a plurality of spaced posts includes:
accessing the information from memory circuitry of a remote-control system that is operably coupled to the at least one limbed vehicle.

53. The method of claim 44, wherein receiving information associated with a plurality of spaced posts includes:
receiving a characteristic sensed about a medium in which at least one of the posts is disposed.

54. The method of claim 44, further comprising:
directing the operation of the at least one limbed vehicle via a remote-control system.

55. The method of claim 44, wherein directing at least one limbed vehicle to travel on the posts using at least one limbs of the limbed vehicle based on the information includes:
directing the at least one limbed vehicle along a route that is based on the information.

56. A limbed vehicle, comprising:
a plurality of controllably movable limbs;
a receiver configured to receive one or more signals containing information associated with at least one post of a plurality of spaced posts; and
a controller operably connected to the receiver and configured to direct movement of at least one of the plurality of controllably movable limbs responsive to the one or more signals.

57. The limbed vehicle of claim 56, wherein the controller is further configured to:
determine a route across the plurality of spaced posts responsive to the signals; and
direct movement of the controllably movable limbs to move the limbed vehicle generally along the route.

58. The limbed vehicle of claim 57, further comprising:
an operator interface operably connected to the controller and through which the route can be selected from a plurality of different routes.

59. The limbed vehicle of claim 58, wherein the operator interface includes an input device.

60. The limbed vehicle of claim 56, wherein the controller is configured to direct at least one of the plurality of controllably movable limbs to at least one post of the plurality of spaced posts responsive to an indication from the one or more signals that the at least one post of the plurality of spaced posts is unoccupied.

61. The limbed vehicle of claim 56, wherein the controller is configured to direct at least one of the plurality of controllably movable limbs to at least one post of the plurality of spaced posts responsive to an indication from the one or more signals that the at least one post of the plurality of spaced posts is occupied.

62. The limbed vehicle of claim 56, further comprising:
at least one transmitter configured to send a request for the information to at least one device associated with at least one post.

63. The limbed vehicle of claim 56, further comprising:
at least one transmitter configured to transmit energy configured to induce the one or more signals as one or more reflected signals that provide the information associated with the at least one post.

64. The limbed vehicle of claim 56, wherein the information is associated with at least one post location, at least one post-occupation status, at least one post configuration, at least one post reactivity, at least one post functionality status, or at least one post orientation.

65. The limbed vehicle of claim 56, wherein the plurality of controllably movable limbs includes a plurality of legs.

66. The limbed vehicle of claim 56, wherein the plurality of controllably movable limbs includes one or more arms.

67. The limbed vehicle of claim 56, wherein at least one of the plurality of controllably movable limbs includes at least one arm that carries an agriculture tool.

68. The limbed vehicle of claim 56, wherein at least one of the plurality of controllably movable limbs includes at least one arm that carries a gripping mechanism.

69. A limbed vehicle, comprising:
a plurality of controllably movable limbs;
memory circuitry including data associated with at least one post of a plurality of spaced posts; and
a controller operably connected to the memory circuitry, and configured to direct movement of at least one of the plurality of controllably movable limbs based at least in part on the data.

70. The limbed vehicle of claim 69, wherein:
the data includes information corresponding to a plurality of different routes; and
the controller is configured to direct the limbed vehicle along at least one selected route of the different routes.

71. The limbed vehicle of claim 69:
wherein the data includes information corresponding to a plurality of different routes; and
further comprising an operator interface operably connected to the controller and to the memory circuitry, the operator interface configured to allow at least one of the different paths to be selected.

72. The limbed vehicle of claim 69, wherein the data includes information corresponding to at least one characteristic of the at least one post.

73. The limbed vehicle of claim 69, wherein the memory circuitry includes at least one memory device.

74. The limbed vehicle of claim 69, wherein the memory circuitry includes at least one storage medium.

75. The limbed vehicle of claim 69, wherein the plurality of controllably movable limbs includes a plurality of legs.

76. The limbed vehicle of claim 75, wherein the plurality of controllably movable limbs includes one or more arms.

77. The limbed vehicle of claim 69, wherein at least one of the plurality of controllably movable limbs includes at least one arm that carries an agriculture tool.

78. A post network, comprising:
a plurality of posts distributed so that at least one limbed vehicle can travel thereon; and
a plurality of sensor devices associated with the plurality of posts, at least one of the plurality of sensor devices configured to:
sense at least one characteristic associated with at least one of the plurality of posts; or
predict a position of the at least one limbed vehicle.

79. The post network of claim 78, wherein the at least one characteristic is:
a position of the at least one of the plurality of posts;
an orientation of the at least one of the plurality of posts;
a configuration of the at least one of the plurality of posts;
a reactivity of the at least one of the plurality of posts;
an occupation status of the at least one of the plurality of posts; or
a functionality status of the at least one of the plurality of posts.

80. The post network of claim 78, wherein at least one of the plurality of posts includes at least one of the plurality of sensor devices operably connected thereto.

81. The post network of claim 78, wherein at least one of the plurality of posts includes at least one of the plurality of sensor devices.

82. The post network of claim 78, further comprising:
a plurality of sensor structures distributed through the plurality of posts, at least one of the plurality of sensor structures including a corresponding one of the plurality of sensor devices.

83. The post network of claim 78, wherein at least one of the plurality of sensor devices is configured to sense information about an environment external to at least one of the plurality of posts.

84. The post network of claim 78, wherein at least one of the plurality of posts has an elongated configuration.

85. The post network of claim 78, wherein at least one of the plurality of posts is configured to reconfigure in response to one or more signals from at least one of the plurality of sensor devices.

86. The post network of claim 85, wherein the at least one of the plurality of posts includes a support structure configured to be selectively moved responsive to the one or more signals from the at least one of the plurality of sensor devices.

87. The post network of claim 78, wherein the plurality of posts are disposed at least partially in a medium, and further wherein the medium includes an agriculture field, an environmentally-sensitive area, or a liquid body.

88. The post network of claim 78, wherein at least one of the plurality of sensor devices includes:
a load sensor;
a thermal sensor;
a global positioning system device;
a local positing system device; or
a machine vision system.

89. The post network of claim 78, wherein at least one of the plurality of sensor devices is configured to be operatively connected to a transmitter for communicating data from one or more of the sensor devices to the at least one limbed vehicle.

90. The post network of claim 78, wherein at least one of the plurality of sensor devices is operatively connected to a receiver configured to receive one or more signals from at least one limbed vehicle.

91. The post network of claim 78, wherein at least one of the plurality of posts is operatively connected to a transmitter for communicating information indicative of a location of at least one post of the plurality of posts to at least one limbed vehicle.

92. A method, comprising:
at least partially supporting a limbed vehicle on at least one first post using at least one first limb of the limbed vehicle; and
responsive to at least one second limb of the limbed vehicle approaching a support structure of at least one second post, moving the support structure so that the at least one second limbed vehicle is at least partially supported thereon using the at least one second limb.

93. The method of claim 92, wherein moving the support structure so that the limbed vehicle is at least partially supported thereon using the at least one second limb occurs responsive to signals received from at least one sensor device associated with the at least one second post.

94. The method of claim 92:
further comprising predicting a location of the at least one second limb; and
wherein moving the support structure so that the limbed vehicle is at least partially supported thereon using the at least one second limb includes moving the support structure to approximately the predicted location of the at least one second limb.

95. The method of claim 92, wherein predicting a location of the at least one second limb includes tracking the movement of the at least one second limb.

96. The method of claim 44, wherein receiving information associated with a plurality of spaced posts includes:
receiving the information responsive to reflecting electromagnetic energy from at least one of the spaced posts.

97. The method of claim 45, wherein receiving sensing information associated with at least one of the spaced posts includes:
receiving a respective functionality status of the at least one of the spaced posts.
